(19) United States
(12) Patent Application Publication
(10) Pub. No.: US 2024/0052506 A1
(43) Pub. Date: Feb. 15, 2024

(54) SUBSTRATE FOR A METAL-SUPPORTED ELECTROCHEMICAL CELL

(71) Applicant: Precision Combustion, Inc., North Haven, CT (US)

(72) Inventors: Toshio Suzuki, New Haven, CT (US); Christian Junaedi, Cheshire, CT (US); Subir Roychoudhury, Madison, CT (US)

(21) Appl. No.: 18/547,195

(22) PCT Filed: Mar. 4, 2022
(86) PCT No.: PCT/US22/18893

§ 371 Date: Aug. 21, 2023

Related U.S. Application Data
(60) Provisional application No. 63/160,187, filed on Mar. 12, 2021.

(51) Int. Cl. C25B 11/069; C25B 9/23; C25B 11/031; C25B 11/052; H01M 4/88; H01M 8/1226; H01M 8/1253; H01M 4/90; H01M 4/86; H01M 8/0245; H01M 8/0232; H01M 8/0236

(52) U.S. Cl. CPC C25B 11/069; C25B 9/23; C25B 11/031; C25B 11/052; H01M 4/8803; H01M 8/1226; H01M 8/1253; H01M 4/9033; H01M 4/8621; H01M 8/0245; H01M 8/0232; H01M 8/0236; H01M 2008/1293

(57) ABSTRACT

A metal substrate for use in a metal-supported electrochemical cell is disclosed, the substrate containing a porous metal support comprising a first metal, such as a ferritic alloy, having applied on one side thereon a barrier layer comprising a bimodal distribution of micron-sized grains of a second metal, for example, nickel, and submicron-sized grains of a metal oxide, for example, gadolinium-doped ceria. A method of fabricating the metal substrate is disclosed. A metal-supported electrode and a metal-supported electrochemical cell are fabricated with the metal substrate.

### CROSS-REFERENCE TO RELATED APPLICATIONS

This invention claims benefit of U.S. provisional patent application No. 63/160,187, filed Mar. 12, 2021, the contents of which are incorporated herein by reference.

### GOVERNMENT RIGHTS

This invention was made with support from the U.S. government under Contract No. 80NSSC19C0577, sponsored by the National Aeronautics and Space Administration. The U.S. Government has certain rights in this invention.

### FIELD OF THE INVENTION

This invention pertains to a metal substrate for use in a metal-supported electrochemical cell. This invention also pertains to methods of fabricating the metal substrate and to the metal-supported electrochemical cell constructed therewith. All components described herein are useful in fabricating and operating, for example, a solid oxide fuel cell (SOFC), a solid oxide electrolysis cell (SOEC) or a solid oxide electrochemical sensor.

### BACKGROUND OF THE INVENTION

An electrochemical cell is comprised of three essential components disposed in a layered configuration: an oxygen electrode, an electrolyte, and a fuel electrode. More particularly, in a solid oxide fuel cell (SOFC) the oxygen electrode functions to reduce molecular oxygen with a source of electrons to oxide ions. The electrolyte functions as a medium to transport the oxide ions from the oxygen electrode to the fuel electrode The fuel electrode functions to oxidize a fuel feed, such as hydrogen and carbon monoxide, with the oxide ions so as to produce water and carbon dioxide with concomitant production of electrons. Methane is another suitable fuel feed. The electrodes are connected via an external electrical circuit, such that the electrons produced at the fuel electrode traverse the external circuit to the oxygen electrode while being available to do electrical work. The voltage achieved from one electrochemical cell is typically small; therefore, a plurality of such cells are connected in series or parallel to form a stack of higher power output.

In order to provide structural support and strength to an electrochemical cell, a porous substrate has been used to anchor either the fuel electrode, the electrolyte, or the oxygen electrode. Among various kinds of substrate materials, a porous metal has been shown to be a desirable substrate for an electrochemical cell for improved performance. Powder metallurgy can be used to prepare the porous metal substrate with varying pore types and sizes. Conventional metal substrates typically have pores in a size range larger than 10 microns (10 μm). These pore sizes, however, are larger than the particle sizes of conventional fuel electrode and electrolyte materials, which are usually in a submicron range. Moreover, the pore sizes of conventional metal substrates are larger than the typical thickness of the individual fuel electrode and electrolyte layers.

The skilled person will appreciate that pore sizes of the metal substrate play an important role in avoiding defects during cell manufacture and operation. Substrates having pores larger than 10 μm are disadvantageously prone to cave-in of electrode and electrolyte layers as well as to undesirable diffusion of metal constituents of electrode and electrolyte layers into the substrate. As an example, under operating conditions chromium in a ferritic substrate can diffuse into an anode of nickel/yttria-stabilized zirconia (Ni-YSZ) forming an undesirable nickel-chromium alloy. Likewise, nickel in the anode can diffuse into the substrate forming undesirable alloys.

The challenge has been to maintain the pore sizes in the metal substrate in a range smaller than 10 μm, in order to ensure that the pore sizes are smaller than the particle sizes of conventional fuel electrode and electrolyte materials applied on top of the metal substrate. Moreover, the pore size of the metal substrate should also be smaller than the typical thickness (5-20 μm) of the individual fuel electrode and electrolyte layers. Disadvantageously, metal substrates with pores smaller than 10 μm are difficult to realize in practical terms of reliable fabrication.

One desirable criterion of a high-performance fuel cell is its ability to achieve a high specific power in units of watts per kilogram (W/kg), which is desirably greater than about 1,000 W/kg, more desirably greater than about 2,000 W/kg. This power output requires a fuel cell that is able to operate at a current density of greater than about 1 Amp per square centimeter (1 A/cm²) while maintaining an acceptably thin and lightweight cell substrate.

It would be desirable to discover an improved porous metal substrate for use in an electrochemical cell such that the substrate provides structural integrity in addition to being thin and lightweight so as to optimize specific power output. It would be desirable if such a substrate could be manufactured substantially flat and defect-free in a thickness of less than about 1.0 millimeter (1.0 mm), preferably, less than about 0.5 mm, and with planar dimensions of up to about 10 centimeters by 10 centimeters (10 cm×10 cm) or greater, depending on its intended application. It would be most desirable for the porous metal substrate to be resistant to electrode cave-in and resistant to diffusion of electrode and electrolyte constituents into the substrate.

### SUMMARY OF THE INVENTION

Our invention eliminates the disadvantages of large-pore metal substrates and the difficulties of fabricating a small-pore metal substrate by incorporation of a novel barrier layer as part of the electrochemical cell. Accordingly, in one aspect, this invention provides for a novel metal substrate for use in a metal-supported electrochemical cell, comprising:
(a) a porous metal support comprising a first metal configured as a layer and having pores ranging in size from about 3 microns to 75 microns;
(b) a barrier layer deposited on one side of the porous metal support, the barrier layer comprising micron-sized grains of a second metal and submicron-sized grains of a metal oxide.

In another aspect, this invention provides for a method of preparing the novel metal substrate for use in a metal-supported electrochemical cell, comprising:
(a) coating one side of a porous metal support comprising a first metal configured as a layer and having pores ranging in size from about 3 microns to 75 microns, with a barrier layer ink comprising a solvent, a binder, micron-sized grains containing a second metal and submicron-sized grains of a metal oxide, so as to form a substrate greenware composite; and
(b) heating the substrate greenware composite under conditions sufficient to form the metal substrate comprising the porous metal support comprising a first metal, configured as a layer and having pores ranging in a size from about 3 microns to 75 microns, and having deposited on the one side thereof a barrier layer comprising micron-sized grains of a second metal and submicron-sized grains of a metal oxide.

In yet another aspect, this invention provides for a novel metal-supported electrode comprising in a layered configuration:
(a) a metal substrate comprising (a)(i) a porous metal support comprising a first metal configured as a layer and having pores ranging in size from about 3 microns to 75 microns; and (a)(ii) a barrier layer deposited on one side of the porous metal support, the barrier layer comprising micron-sized grains of a second metal and submicron-sized grains of a metal oxide; and
(b) an electrode layer applied on top of the barrier layer.

In yet another aspect, this invention provides for a process of preparing the aforementioned metal-supported electrode comprising:
(a) coating one side of a layer of a porous metal support comprising a first metal having pores ranging in size from about 3 microns to 75 microns, with a barrier layer ink comprising a solvent, a binder, micron-sized grains containing a second metal and submicron-sized grains of a metal oxide so as to form a substrate greenware composite;
(b) coating the substrate greenware composite with an electrode ink comprising a solvent, a binder, and particles of an electrode material so as to form a green electrode composite; and
(c) heating the green electrode composite under conditions sufficient to form the metal-supported electrode.

In yet another aspect, this invention provides for a novel metal-supported electrochemical cell, comprising in a layered configuration:
(a) a metal substrate comprising (a)(i) a porous metal support comprising a first metal configured as a layer and having pores ranging in size from about 3 microns to 75 microns, and (a)(ii) a barrier layer comprising micron-sized grains of a second metal and submicron-sized grains of a metal oxide, the barrier layer deposited on one side of the metal substrate;
(b) a first electrode layer applied on top of the barrier layer;
(c) an electrolyte layer applied on top of the first electrode layer; and
(d) a second electrode layer applied on top of the electrolyte layer, the second electrode layer having a polarity opposite that of the first electrode layer.

The invention described hereinabove provides for a novel porous metal substrate and a novel method of fabricating the same, which finds utility in a metal-supported electrochemical cell, such as a metal-supported solid oxide fuel cell (MS-SOFC) or solid oxide electrolysis cell (SOEC) or solid oxide electrochemical sensor. Advantageously, this invention is able to realize cells having substantially flat and defect-free layer surfaces with planar dimensions of up to about 10 cm by 10 cm or greater, and with a substrate thickness of less than about 1.0 mm, preferably, between about 0.1 mm and 0.50 mm. Minimizing the cell thickness while maintaining substantially flat and defect-free layer surfaces is important to permit lower cell weight and a higher cell specific power, desirably, greater than about 1,000 W/kg, and more desirably, greater than about 2,000 W/kg.

Fabrication of a metal-supported solid oxide cell (MS-SOC) is completed by screen printing layers of cell components, then debinding and sintering. A barrier layer ink formulation is selected based on criteria described hereinafter, and is applied in order to reduce significantly, if not completely eliminate, cave-in and diffusion of cell components due to the large pore size of the porous metal support. The resulting novel barrier layer comprising a bimodal distribution of micron-sized grains and submicron-sized grains is selected so as to fill-in gaps and pores of the metal support in a size ranging between about 3 μm and 75 μm. All of the process routes described herein are novel to this invention in order to obtain a thin substrate with high current density resulting in a solid oxide cell of high specific power of greater than about 1,000 W/kg.

Implementation of the novel MS-SOFC opens up opportunities for high power density, fast-response, and durable fuel cell generators for many applications including aerospace, defense and energy sector applications. The metal-supported cells of this invention allow design of lighter, more thermally effective, efficient and durable electrochemical cell stacks.

### BRIEF DESCRIPTION OF THE DRAWINGS

FIG. 1 depicts in cross-sectional view an electrochemical cell in which an anode is supported on a substrate comprising a porous metal support coated with a barrier layer.

FIG. 2 presents a polarization curve (I-V and I-P plots) obtained from operating an embodiment of the metal-supported solid oxide fuel cell of this invention.

### DETAILED DESCRIPTION OF THE INVENTION

For the purposes of this invention, the term “grains” refers to crystallites or particles of varying and randomly distributed small sizes as noted herein.

As used herein, the word “layer” refers to a quasi-two-dimensional structure wherein dimensions of length and width are significantly larger than dimension of thickness. A layer can be considered a plane or sheet of one thickness of a first material that covers all or a portion of the surface of a second material. The term as used herein does not limit the layer to any particular shape; for example, the layer can be in the form of a square, rectangle, hexagon, circle, ellipse, or any other shape as dictated by design. Generally, all layers in the cell have the same shape so that they can be matched, sealed, and secured on edges and corners.

Where a range is set forth, the word “about” is placed before the lower limit of the range. Unless otherwise noted, the word “about” is intended to modify both the lower and upper limits of the range allowing for an acceptable variance in both lower and upper limits.

A technical advantage of this invention involves fabrication of a substantially flat substrate layer, which allows for a secure and tight-fitting application of an electrode layer thereupon. The term “flat” refers to a level surface characterized by lines or tracings substantially without peaks and valleys. An acceptable level of flatness can be determined by visual inspection, looking for warpage or deformation of the surface, either without magnification or through an optical microscope offering about 10 to 20 times magnification.

Another technical advantage of this invention involves fabrication of a substantially defect-free substrate layer, which means that the layer does not contain an unacceptable number of fractures, hairline cracks, pinholes, and other imperfections in surface uniformity. As with inspection for warpage, defects can be identified by visual inspection without magnification of the surface of the substrate layer or any other exposed cell layer. Alternatively, the desired surface can be visually inspected under an optical microscope of about 10 to 20 times magnification. Inspection of a half-cell comprising the porous metal support, the barrier layer, the fuel electrode and the electrolyte is particularly beneficial prior to applying the cathode layer.

Yet another technical advantage of this invention involves fabrication of a thin and light-weight substrate defined herein as the composite comprising the porous metal support and the barrier layer. Substrates of this invention advantageously have a thickness less than about 1.1 millimeters (1.1 mm), and typically between about 100 microns (100 μm) and about 1,000 microns (1,000 μm).

In one illustrative embodiment, the novel metal substrate for use in the metal-supported electrochemical cell comprises:
(a) a porous metal support comprising a first metal selected from the group consisting of nickel, iron, cobalt, chromium, copper, manganese, and mixtures thereof, configured as a layer and having pores ranging in size from about 3 microns to 75 microns;
(b) a barrier layer deposited on to one side of the porous metal support, the barrier layer comprising micron-sized grains of a second metal selected from the group consisting of nickel, iron, cobalt, chromium, copper, manganese, and mixtures thereof, the micron-sized grains ranging in size from about 2 microns (2 μm) to 20 microns (20 μm); the barrier layer further comprising submicron-sized grains of a metal oxide comprising a third metal selected from the group consisting of cerium, gadolinium, samarium, lanthanum, yttrium, chromium, titanium, calcium, strontium, iron, nickel, cobalt, aluminum, manganese, and mixtures thereof, the submicron-sized grains ranging in size from about 0.1 micron (0.1 μm) to less than 1 micron (1 μm).

In another illustrative embodiment, the layer of porous metal support has a thickness ranging from about 80 microns (80 μm) to 1,000 microns (1,000 μm) and a porosity greater than about 20 volume percent, and in a preferred embodiment ranging from about 25 volume percent to 50 volume percent.

In another illustrative embodiment, the layer of porous metal support comprises a ferritic alloy, preferably, a ferritic alloy containing chromium in an amount greater than about 15 weight percent.

In another illustrative embodiment, the barrier layer has a thickness ranging from about 10 microns (10 μm) to 50 microns (50 μm).

In another illustrative embodiment, the barrier layer comprises micron-sized grains of a second metal selected from the group consisting of nickel and copper. In another illustrative embodiment, the barrier layer comprises submicron-sized grains of a metal oxide wherein the metal oxide is ceria or a rare-earth doped ceria. In another illustrative embodiment, the barrier layer comprises submicron-sized grains of a metal oxide wherein the metal oxide is lanthanum chromite or a rare-earth doped lanthanum chromite. In yet another illustrative embodiment, the barrier layer comprises submicron-sized grains of a metal oxide wherein the metal oxide is strontium titanate or a rare-earth doped strontium titanate.

In yet another illustrative embodiment, this invention provides for a metal-supported electrode comprising in a layered configuration:
(a) a metal substrate comprising (a)(i) a porous metal support comprising a first metal selected from the group consisting of nickel, iron, cobalt, chromium, copper, manganese, and mixtures thereof, configured as a layer and having pores ranging in size from about 3 microns to 75 microns; and (a)(ii) a barrier layer deposited on one side of the porous metal support, the barrier layer comprising micron-sized grains of a second metal selected from the group consisting of nickel iron, cobalt, chromium, copper, manganese, and mixtures thereof, the micron-sized grains ranging in size from about 2 microns (2 μm) to 20 microns (20 μm); the barrier layer further comprising submicron-sized grains of a metal oxide comprising a third metal selected from the group consisting of cerium, gadolinium, samarium, lanthanum, yttrium, chromium, titanium, calcium, strontium, iron, nickel, cobalt, aluminum, manganese, and mixtures thereof, the submicron-sized grains ranging in size from about 0.1 micron (0.1 μm) to less than 1 micron (1 μm); and
(b) an electrode layer applied on top of the barrier layer.

In yet another illustrative embodiment, this invention provides for a novel metal-supported electrochemical cell, comprising in a layered configuration:
(a) a metal substrate comprising (a)(i) a porous metal support comprising a first metal selected from the group consisting of nickel, iron, cobalt, chromium, copper, manganese, and mixtures thereof, configured as a layer and having pores ranging in size from about 3 microns to 75 microns; and (a)(ii) a barrier layer deposited on one side of the porous metal support, the barrier layer comprising micron-sized grains of a second metal selected from the group consisting of nickel iron, cobalt, chromium, copper, manganese, and mixtures thereof, the micron-sized grains ranging in size from about 2 microns (2 μm) to 20 microns (20 μm); the barrier layer further comprising submicron-sized grains of a metal oxide comprising a third metal selected from the group consisting of cerium, gadolinium, samarium, lanthanum, yttrium, chromium, titanium, calcium, strontium, iron, nickel, cobalt, aluminum, manganese, and mixtures thereof, the submicron-sized grains ranging in size from about 0.1 micron (0.1 μm) to less than 1 micron (1 μm); and
(b) a first electrode layer applied on top of the barrier layer;
(c) an electrolyte layer applied on top of the first electrode layer; and
(d) a second electrode layer applied on top of the electrolyte layer, the second electrode layer having a polarity opposite that of the first electrode layer.

In yet another illustrative embodiment, the aforementioned electrochemical cell comprises a metal-supported solid oxide fuel cell or a metal-supported solid oxide electrolysis cell, wherein the first electrode layer is a fuel electrode layer and the second electrode layer is an oxygen (or air) electrode layer. In another illustrative embodiment, the fuel electrode layer has a thickness between about 3 microns and 20 microns; the electrolyte layer has a thickness between about 1 micron and 20 microns; and the oxygen electrode layer has a thickness between about 10 microns and 30 microns.

In another illustrative embodiment, the fuel electrode layer is a composite comprising nickel or nickel oxide in combination with a metal oxide selected from the group consisting of the oxides of zirconium, yttrium, cerium, scandium, gadolinium, samarium, calcium, lanthanum, strontium, magnesium, gallium, barium, and mixtures thereof. In one preferred embodiment the fuel electrode layer is nickel oxide-yttria stabilized zirconia, NiO-YSZ.

In yet another illustrative embodiment, the electrolyte layer comprises a metal oxide selected from the group consisting of the oxides of zirconium, yttrium, cerium, scandium, gadolinium, samarium, lanthanum, strontium, magnesium, gallium, barium, calcium and mixtures thereof. In one preferred embodiment, the electrolyte layer is yttria-stabilized zirconia.

In yet another illustrative embodiment, the oxygen electrode layer is selected from compositions of formula ABO₃, wherein A is selected from the group consisting of barium, strontium, lanthanum, samarium, praseodymium, and combinations thereof, and B is selected from the group consisting of iron, cobalt, nickel and manganese. In a preferred embodiment, the ABO₃ is lanthanum strontium cobalt ferrite (LaSrCoFeO₃).

In another illustrative embodiment of the electrochemical cell, an interlayer is applied in between the electrolyte layer and the oxygen electrode layer, optionally further wherein the interlayer has a thickness between about 1 micron and 20 microns. The interlayer functions to retard reaction between the electrolyte and the oxygen (or cathode) materials. Typically, the interlayer comprises one or more rare earth elements doped with one or more metals selected from Group IIA elements. In one embodiment, the one or more rare earth elements are selected from the group consisting of lanthanum, samarium, yttrium, gadolinium, and combinations thereof. In one embodiment, the interlayer is comprised of a doped ceria.

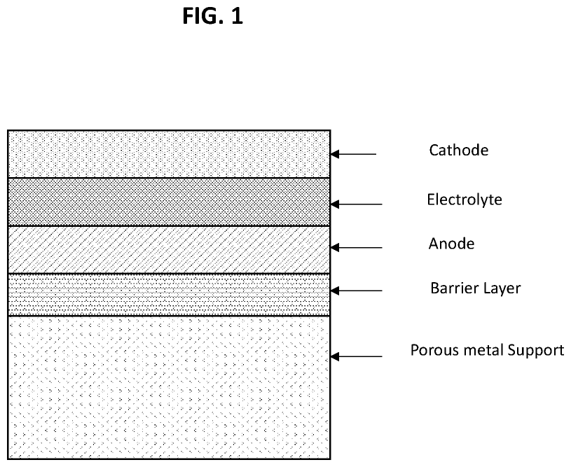

As an aid to understanding the invention, reference is made to FIG. 1, which depicts in cross-sectional view an embodiment of an electrochemical cell as envisioned in this invention. A person skilled in the art will appreciate that the electrochemical cell comprises at least five layers in the following order from bottom to top as shown: a porous metal support, a barrier layer, a fuel electrode (anode), an electrolyte, and an oxygen electrode (cathode). In this invention, a barrier layer of specific chemical composition is disposed in between the fuel electrode and the porous metal support of specific pore size.

Generally, the porous metal support comprises any metallic material providing acceptable strength, electrical conductivity, and thermal coefficient of expansion for use in an electrochemical cell. Such porous metal supports are typically provided as a pure metallic element or a combination of metallic elements as in an alloy. Non-limiting illustrative examples of metal supports suitable for this invention include ferritic alloys predominantly those comprising iron and an amount of chromium over 15 weight percent, as well as smaller amounts of other metallic elements. The porous metal support typically is formed into a thin sheet or layer with a thickness ranging from about 80 microns (0.08 mm) to 1,000 microns (1 mm), preferably, from about 100 microns (0.1 mm) to 500 microns (0.5 mm). More importantly, the metal support is required to be “porous”, meaning that a plurality of pores, channels, and/or open cells are present throughout and within the support so as to facilitate diffusion of gaseous components there through. The porosity is typically greater than 20 volume percent (20 vol. percent), and preferably, in a range from about 25 vol. percent to 50 vol. percent, based on the total volume of the metal support

Porous metal supports in the shape of a sheet or layer at the upper end of the thickness range (800-1,000 μm) can be purchased from commercial suppliers. Below about 500 μm thickness, the porous metal support can be fabricated by tape-casting methods known in the art. Generally, tape casting involves preparing a slurry comprising a solvent, a binder, a powdered form of the metallic element, alloy or precursor thereto, a pore former, and optionally, at least one of a plasticizer and dispersant; and casting the slurry into a sheet or film in a selected thickness. Thereafter, the solvent is removed forming a greenware; and the greenware is subjected to an oxidizing atmosphere under air at a temperature between about 300° C. and 800° C. in a debinding or firing step. Thereafter, the greenware is further subjected to heating under a reducing atmosphere, for example, a mixture of hydrogen and inert gas, such as argon or nitrogen, to form a more densified material, which nevertheless is the porous metal support. See, for example, US 2008/0096079, incorporated herein by reference, on the subject of preparing a thin-layer porous metal support from metal powder.

The micron-sized grains of second metal in the barrier layer are generally obtained from metals providing for acceptable electrical conductivity, relative to the electrical conductivity of the electrode layer intended to be deposited upon the barrier layer. Generally, the second metal is selected to match or closely match the electron conductive metal in the selected electrode, so as to reduce electrical resistance between the barrier layer and the electrode. In one embodiment, the second metal of the barrier layer is selected from the group consisting of nickel iron, cobalt, chromium, copper, manganese, and mixtures thereof. Among these, nickel is one desirable embodiment. The micron-sized grains of the second metal in the barrier layer function to fill-in gaps within the porous metal support and along the interface between the barrier layer and the porous metal support.

The submicron-sized grains of the metal oxide of the barrier layer are generally obtained from metal oxides that provide for suitable porosity and oxide ion (O²⁻) conductivity. In one embodiment, the metal oxide, provided in submicron-sized grains, comprise a third metal selected from the group consisting of cerium, gadolinium, samarium, lanthanum, yttrium, chromium, titanium, calcium, strontium, iron, nickel, cobalt, aluminum, manganese, and mixtures thereof. Among these, various embodiments are desirable. In one illustrative embodiment, the metal oxide of the barrier layer is ceria or a rare earth doped ceria. In another illustrative embodiment, the metal oxide of the barrier layer is lanthanum chromite or a rare earth doped lanthanum chromite. In yet another illustrative embodiment, the metal oxide of the barrier layer is strontium titanate or a rare earth doped strontium titanate. The submicron size functions to fill-in gaps between the micron-sized grains thereby providing for uniformly flat and defect-free surfaces, notably on one side at the interface of the barrier layer and the metal support, and notably on the other side at the interface of the barrier layer and the electrode.

In preparing the substrate of this invention, the porous metal support is first coated with a barrier layer ink comprising a solvent, a binder, powder particles of the micron-sized second metal, and powder particles of the submicron sized metal oxide. Usually, the ink also contains a plasticizer, or a dispersant, or a mixture thereof. Generally, the micron-sized particles are provided in the ink as particles of the selected second metal either in its elemental form or as its oxide, for example, nickel or nickel oxide. The micron-sized particles disposed in the ink typically range in size from about 1 micron to 10 microns. The quantity of micron-sized particles in the ink ranges from about 34 to 65 wt. percent, based on the total weight of metals content of the ink. The submicron-sized particles are provided in the ink as particles of the selected metal oxide, which typically range in size from about 0.05 micron to 0.5 micron. Generally, the amount of submicron sized particles in the ink ranges from about 35 to 66 wt. percent, based on the total weight of metals content of the ink.

The solvent employed in the ink is selected typically from common organic solvents that are easily removed at a temperature between about 50° C. and 120° C. Such solvents are generally selected from the group consisting of alcohols, esters, and ketones, and are typically supplied in an amount ranging from about 5 to 20 wt. percent, based on the total weight of the ink. The binder is selected from commercial binder formulations, for example, alcohol and polyvinyl-based binders, in an amount ranging from about 5 to 20 wt. percent. Suitable plasticizers include those from phthalate and glycol groups, added typically in an amount ranging from about 1 to 10 wt. percent. Suitable dispersants include fish oil and amine groups provided in an amount ranging from about 1 to 10 wt. percent. After thorough mixing of all components, the barrier layer ink is screen printed onto one side of the porous metal support thereby producing a green substrate composite.

After ink printing, the green substrate composite is subjected to debinding and sintering in a two-stage thermal treatment under conditions sufficient to obtain the porous metal substrate of this invention. The first stage of the thermal treatment is conducted under flowing air. The heating is achieved by raising the temperature of the support-ink composite into a range between about 60° C. and 450° C. The second stage in sintering the greenware substrate is conducted under a reducing mixture of hydrogen and an inert gas, such as helium, nitrogen or argon, by raising temperature to a range between about 900° C. and 1400° C., so as to form and bond the barrier layer onto the porous metal support. Functionally, the barrier layer provides the advantage of preventing cave-in of cell constituents into the pores of the metal support as well as undesirable diffusion of support constituents into the electrode. Yet, the porosity of the metal support and barrier layer allow for diffusion of gas components into and out of the substrate. Moreover, the barrier layer components are selected to correspond acceptably in electrical conductivity, oxide ion conductivity, and thermal coefficient of expansion to those values of the electrode to be deposited thereon.

Materials useful for the fuel and oxygen electrodes should be stable at operating temperatures; should have a coefficient of thermal expansion compatible with that of the solid oxide electrolyte; and should be chemically compatible with the solid oxide electrolyte and other materials during fabrication and operation of the solid oxide cell. In forward operation, the function of the fuel electrode is to combine the oxide ions that diffuse through the electrolyte with the fuel supplied to the fuel electrode to produce water and carbon dioxide as well as to produce a flow of electrons.

The skilled person should appreciate that this invention is not limited to any specific fuel electrodes, electrolytes, or oxygen electrodes. Any of these known in the art can be suitably employed in this invention. Typically, however, the fuel electrode is constructed of a porous cermet layer that allows the fuel, generally a gaseous reformate comprising hydrogen and carbon monoxide, to diffuse inside the electrode. Since the fuel electrode must be electrically and ionically conductive, the fuel electrode typically comprises a combination of ceramic and metal (cermet) prepared by standard ceramic processing techniques. Suitable fuel electrode layers comprise, for example, nickel or nickel oxide and a metal oxide selected from the group consisting of the oxides of zirconium, yttrium, cerium, scandium, gadolinium, samarium, calcium, lanthanum, strontium, magnesium, gallium, barium, and mixtures thereof. In one embodiment the fuel electrode layer comprises nickel oxide-yttria stabilized zirconia, NiO-YSZ.

The solid oxide electrolyte comprises a dense layer of ceramic that conducts oxide ions (O²⁻). Typically, the electrolyte comprises a metal oxide selected from the group consisting of scandium, cerium, zirconium, lanthanum, strontium, magnesium, gallium, barium, yttrium, gadolinium, samarium, calcium, and mixtures thereof. As an example of a material from which the solid oxide electrolyte layer can be made, we include yttria-stabilized zirconia (YSZ) and scandia-stabilized zirconia (ScSZ). As newer electrolytes are developed, these may lead to more robust materials and less resistivity problems by improving the conductivity of oxide ions, which in turn may lead to better performing electrolyte layers, any of which may be employed in this invention.

The oxygen electrode should also be porous so as to provide for a uniform flow of oxygen throughout the electrode and should be capable of conducting oxide ions (O⁻²) to the solid oxide electrolyte. As non-limiting examples of a material from which the oxygen electrode can be formed, lanthanum strontium manganite (LSM), lanthanum strontium ferrite (LSF), (La,Sr)(Co,Fe)O₃ and any of the cobalites are included.

The fuel electrode, electrolyte, and oxygen electrode layers are fabricated from individual inks that are screen printed and heat treated. The ink typically contains a solvent, a binder, the ceramic and metallic components of the particular layer involved, and optionally, at least one of a plasticizer and dispersant. As an illustrative embodiment, the ink for the fuel electrode layer comprises a solvent, cermet powder precursors to the fuel electrode layer, binder, plasticizer, and dispersant. After thorough mixing, the fuel electrode ink is screen printed over the barrier layer and dried at a temperature between about 60° C. and 120° C. Then the electrolyte ink is screen printed over the fuel electrode layer. The multilayer composite comprising the porous metal support, the barrier layer, the printed fuel electrode layer, and the printed electrolyte layer is heat treated first under air and then under a reducing atmosphere as previously described herein to construct a metal-supported half cell. The sintering temperature of the electrolyte and anode layers is typically in a range up to 1400° C. After sintering, the oxygen electrode layer is constructed by screen printing the oxygen electrode ink over the electrolyte layer.

Any individual electrochemical cell produces less than about 1 V under typical operating conditions, but most applications require higher voltages. Accordingly, for practical applications a plurality of individual electrochemical cells of this invention are connected in series or parallel to form a stack so as to obtain a higher voltage required for the application. The stack is constructed by securing each electrochemical cell between two interconnects that provide strength to the stack and separate the cells from each other.

Since the interconnects are exposed at high temperatures to both oxidizing and reducing sides of the cell, the interconnects should be stable under both circumstances. Accordingly, the interconnects are comprised of an electrically conductive material that is able to withstand the thermal and chemical environments to which they are exposed. In one embodiment, the interconnects are constructed of metallic plate or foil, for example, a high temperature stainless steel alloy. In another embodiment, the interconnects are constructed from cermets providing for acceptable thermal stability and electrical conductivity. This invention is not limited to any particular interconnect material or interconnect layer thickness.

### Example

A metal substrate comprising a porous metal support and a barrier layer was constructed in accordance with the method of this invention, in this case starting from a ferritic metal powder. The ferritic metal powder (FeCr alloy, 10 μm average particle size) and a PMMA pore former (polymethylmethacrylate, 8 μm average particle size) were mixed with a commercial formulation of solvent, binder and plasticizer; and the resulting mixture was tape casted. The green sheet thusly prepared was heat treated under air to debind the organic materials and subsequently sintered under a mixture of hydrogen and inert gas to prepare the porous metal support having a thickness of 0.45 mm (450 μm) and an average pore size of 10 μm.

The porous metal support was coated by screen printing with a barrier layer ink comprising: a solvent (alcohol), a polyvinyl binder (6 g), a phthalate plasticizer (1 g), a dispersant (fish oil, 1 g), micron-sized particles of nickel (30 g, 5 μm), and submicron-sized particles of gadolinium-doped ceria (20 g, 0.05 μm, 10% Gd) to form a green substrate composite.

The green substrate composite was coated by screen-printing with a fuel electrode (anode) ink comprising alcohol (6 g), polyvinyl binder (6 g), a phthalate plasticizer (1 g), a dispersant (fish oil, 1 g), nickel oxide (30 g), and yttria-stabilized zirconia (20 g), so as to form a green fuel electrode composite.

The green fuel electrode composite was coated by screen-printing, in the manner previously described, with an electrolyte ink comprising alcohol (10 g), polyvinyl binder (6 g), phthalate plasticizer (2 g), fish oil dispersant (2 g), and scandium-stabilized zirconia (50 g) to form a green half-cell.

The thusly-prepared green half-cell was co-sintered using the following heating protocol: starting at room temperature, heating under air up to a temperature of 400° C. and holding for a time between 1 and 5 hours; then raising the temperature under a mixture of hydrogen (5 vol. percent) in inert gas to a temperature of 1320° C. and holding, for a time between 1 and 5 hours, then cooling under the flow of hydrogen in inert gas.

Scanning Electron Microscopy (SEM) was conducted on the sintered half-cell. EDS spectra indicated successful metal-supported solid oxide half-cell fabrication with a clear boundary (interface) between adjacent layers of the half-cell, including the porous metal support, the barrier layer, the fuel electrode (anode), and the electrolyte. In addition, the surface of the top layer, the electrolyte, was observed to be flat and uniform without warpage and defects. Overall, the half-cell structure was acceptable for oxygen electrode deposition and fuel cell performance testing.

The thusly-prepared metal-supported half-cell was used to fabricate a metal-supported solid oxide fuel cell (MS-SOFC) which was tested for cell performance. The half-cell was coated over the electrolyte layer via screen printing with a green oxygen electrode layer comprising LaSrCoFeO₃. The greenware was sintered under the aforementioned protocol to form the MS-SOFC (11 gm, 0.8 mm thick).

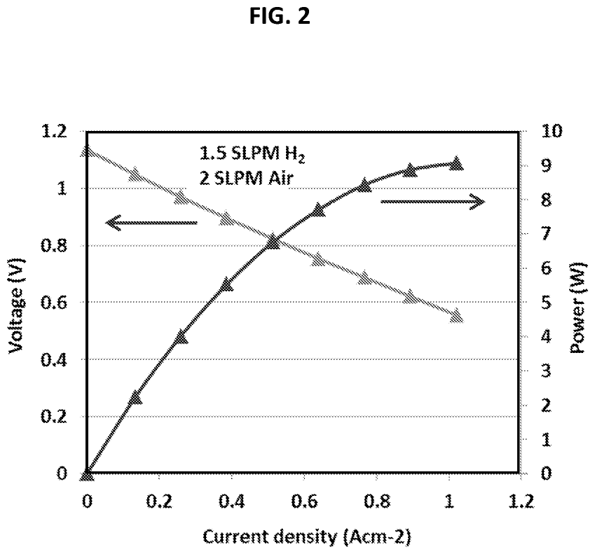

FIG. 2 illustrates a polarization curve, namely, the I-V/I-P plots, from MS-SOFC testing. Test results indicated that at 750° C. the cell open circuit voltage (OCV) was slightly higher than 1.10 V, which indicated a healthy cell; and the cell obtained a current density of essentially 1 A/cm². As can be seen in FIG. 2, nominal cell current density was 0.7 A/cm², producing 8 Watts of power (using 5×5 cm² cell area with 4×4 cm² active area). A cell peak power at 1 A/cm² was calculated to be 12 Watts, corresponding to a cell specific power of 1,000 W/kg.

Based on these results for the cell of 0.8 mm thickness, and assuming that the same cell performance can be maintained, a thinner MS-SOFC (7 g, 0.45 mm thick cell) and an even thinner MS-SOFC (4.5 g, 0.27 mm thick cell) demonstrate a significant improvement in the cell specific power. For example, 12 Watts of power generated from a single cell (for a 5×5 cm² cell area with 4×4 cm² active area) result in about 1700 W/kg and 2600 W/kg of cell specific power, respectively, for the 0.45 mm thick and 0.27 mm thick cells.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A metal substrate suitable for use in a metal-supported electrochemical cell, comprising:
(a) a porous metal support comprising a first metal, configured as a layer and having pores ranging in size from 3 microns to 75 microns; and
(b) a barrier layer applied onto one side of the porous metal support, the barrier layer comprising micron-sized grains of a second metal and submicron-sized grains of a metal oxide.

2. The metal substrate according to claim 1 wherein the layer of the porous metal support has a thickness ranging from 80 microns to 1,000 microns.

3. The metal substrate according to claim 1 wherein the layer of the porous metal support has a porosity ranging from 25 vol. percent to 50 vol. percent.

4. The metal substrate according to claim 1 wherein the layer of porous metal support comprises a ferritic alloy, optionally, wherein the ferritic alloy comprises chromium in an amount greater than 15 mole percent.

5. The metal substrate according to claim 1 wherein the barrier layer has a thickness ranging from 10 microns to 50 microns.

6. The metal substrate according to claim 1 wherein the micron-sized grains of the second metal range in size from 2 microns to 20 microns.

7. The metal substrate according to claim 1 wherein the second metal is selected from the group consisting of nickel iron, cobalt, chromium, copper, manganese, and mixtures thereof.

8. (canceled)

9. The metal substrate according to claim 1 wherein the submicron-sized grains of metal oxide range in size from 0.1 micron to less than 1 micron.

10. The metal substrate according to claim 1, wherein the metal oxide comprises a third metal selected from the group consisting of cerium, gadolinium, samarium, lanthanum, yttrium, chromium, titanium, calcium, strontium, iron, nickel, cobalt, aluminum, manganese, and mixtures thereof.

11. The metal substrate according to claim 1 wherein the submicron-sized grains of the metal oxide comprise ceria or a rare-earth doped ceria; or wherein the submicron-sized grains of the metal oxide comprise lanthanum chromite or a rare earth-doped lanthanum chromite; or wherein the submicron-sized grains of the metal oxide comprise strontium titanate or a rare earth-doped strontium titanate.

12. The metal substrate according to claim 11 wherein the micron-sized grains comprise nickel.

13. A process of preparing the metal substrate of claim 1, comprising:
(a) coating one side of a porous metal support, comprising a first metal configured as a layer and having pores ranging in size from 3 microns to 75 microns, with a barrier layer ink comprising a solvent, a binder, micron-sized grains containing a second metal and submicron-sized grains of a metal oxide, so as to form a substrate greenware composite;
(b) heating the substrate greenware composite under conditions sufficient to form the porous metal substrate comprising the porous metal support, configured as a layer and having pores ranging in a size from 3 microns to 75 microns, and having deposited on the one side thereof a barrier layer comprising micron-sized grains comprising a second metal and submicron-sized grains of a metal oxide.

14. A metal-supported electrode comprising in a layered configuration:
(a) a metal substrate comprising (a)(i) a porous metal support comprising a first metal, configured as a layer and having pores ranging in size from 3 microns to 75 microns; and (a)(ii) a barrier layer deposited on one side of the porous metal support, the barrier layer comprising micron-sized grains of a second metal and submicron-sized grains of a metal oxide; and
(b) an electrode layer deposited on the barrier layer.

15. The metal-supported electrode in accordance with claim 14 wherein the porous metal support comprises a ferritic alloy and wherein the barrier layer comprises micron-sized grains of nickel and submicron-sized grains of ceria or a rare earth doped ceria; and further wherein the electrode is a fuel electrode comprising nickel and yttria-stabilized zirconia.

16. (canceled)

17. A process of preparing the metal-supported electrode of claim 14 comprising:
(a) coating one side of a layer of a porous metal support, comprising a first metal and having pores ranging in size from 3 microns to 75 microns, with a barrier layer ink comprising a solvent, a binder, micron-sized grains comprising a second metal and submicron-sized grains of a metal oxide so as to form a substrate greenware composite;
(b) coating the substrate greenware composite with an electrode ink to form a green electrode composite; and
(c) heating the green electrode composite under conditions sufficient to form the metal-supported electrode.

18. An electrochemical cell comprising in a layered configuration:
(a) a metal substrate comprising (a)(i) a porous metal support comprising a first metal, configured as a layer and having pores ranging in size from 3 microns to 75 microns; and (a)(ii) a barrier layer deposited on one side of the porous metal support, the barrier layer comprising micron-sized grains of a second metal and submicron-sized grains of a metal oxide;
(b) a first electrode layer applied on top of the barrier layer;
(c) an electrolyte layer applied on top of the first electrode layer; and
(d) a second electrode layer applied on top of the electrolyte layer, the second electrode layer having a polarity opposite that of the first electrode layer.

19.-28. (canceled)

29. The metal-supported electrochemical cell of claim 18 wherein the first electrode is a fuel electrode comprising nickel or nickel oxide in combination with a metal oxide selected from the group consisting of the oxides of zirconium, yttrium, cerium, scandium, gadolinium, samarium, calcium, lanthanum, strontium, magnesium, gallium, barium, and mixtures thereof.

30. The metal-supported electrochemical cell of claim 18 wherein the electrolyte comprises a metal oxide selected from the group consisting of the oxides of zirconium, yttrium, cerium, scandium, gadolinium, samarium, lanthanum, strontium, magnesium, gallium, barium, calcium and mixtures thereof.

31. The metal-supported electrochemical cell of claim 18 wherein the second electrode is an oxygen electrode layer selected from compositions of formula ABO₃, wherein A is selected from the group consisting of barium, strontium, lanthanum, samarium, praseodymium, or a combination thereof, and B is selected from the group consisting of iron, cobalt, nickel and manganese.

32. The metal-supported electrochemical cell of claim 18 wherein the electrochemical cell comprises a solid oxide fuel cell or a solid oxide electrolysis cell.

33. The metal supported electrochemical cell of claim 18 wherein the second electrode is an oxygen electrode; and where an interlayer is disposed in between the oxygen electrode and the electrolyte, the interlayer having a thickness of between 1 micron and 20 microns.
